(19) United States
(12) Patent Application Publication
(10) Pub. No.: US 2026/0099277 A1
(43) Pub. Date: Apr. 9, 2026

(54) ELECTRONIC DEVICE INCLUDING STORAGE DEVICE AND METHOD THEREOF

(71) Applicant: Samsung Electronics Co., Ltd., Suwon-si (KR)

(72) Inventors: Junwoo LEE, Suwon-si (KR); Wonkon KIM, Suwon-si (KR); Wonsuk JUNG, Suwon-si (KR)

(21) Appl. No.: 19/416,416

(22) Filed: Dec. 11, 2025

Related U.S. Application Data
(63) Continuation of application No. PCT/KR2024/010914, filed on Jul. 26, 2024.

(30) Foreign Application Priority Data
Aug. 30, 2023 (KR) 10-2023-0114413
Jul. 28, 2023 (KR) 10-2023-0099159

(51) Int. Cl. G06F 3/06; G06F 12/02

(52) U.S. Cl. CPC G06F 3/0679; G06F 3/0619; G06F 3/0634; G06F 3/0655; G06F 12/0246; G06F 2212/7206

(57) ABSTRACT

A universal flash storage (UFS) device controller is provided. The UFS device controller is configured to, based on an error identified through a UFS interface, identify that a state related to the UFS interface is changed from a first state in which data is transferred based on a first data processing speed to a second state in which data is transferred based on a second data processing speed different from the first data processing speed, wherein the UFS device controller is configured to, while the second state is maintained, after a designated time for identifying whether to process cache data stored in cache memory from a time point at which a change from the first state to the second state is identified, transmit the cache data stored in cache memory from the cache memory to non-volatile memory.

### CROSS-REFERENCE TO RELATED APPLICATIONS

This application is a continuation application, claiming priority under 35 U.S.C. § 365(c), of an International application No. PCT/KR2024/010914, filed on July 26, 2024, which is based on and claims the benefit of a Korean patent application number 10-2023-0099159, filed on July 28, 2023, in the Korean Intellectual Property Office, and of a Korean patent application number 10-2023-0114413, filed on August 30, 2023, in the Korean Intellectual Property Office, the disclosure of each of which is incorporated by reference herein in its entirety.

### BACKGROUND

### 1. Field

The disclosure relates to an electronic device including a storage device and a method.

### 2. Description of Related Art

A semiconductor memory device may be divided into volatile memory device that loses stored data when a power supply is interrupted and non-volatile memory device that does not lose stored data. The volatile memory device has fast read and write speeds, but stored content may disappear when an external power supply is cut off. On the other hand, the non-volatile memory device has slower read and write speeds compared to the volatile memory device, but may preserve its content even when the external power supply is cut off. More particularly, the non-volatile memory, such as flash memory may be widely used as a storage device in various fields due to advantages, such as a large capacity, a low noise, and a low power. In particular, a solid state drive (SSD) implemented based on the flash memory may be used as a mass storage device in various devices, such as a personal computer, a laptop, a workstation, and a server system.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a storage device and a method.

Additional aspects will be set forth in part in the description which follows and, in part, will be apparent from the description, or may be learned by practice of the presented embodiments.

In accordance with an aspect of the disclosure, an electronic device is provided. The electronic device includes at least one processor, a universal flash storage (UFS) device controller operatively coupled to the at least one processor, a UFS interface including a downstream lane for transmitting data from the at least one processor to the UFS device controller and an upstream lane for transmitting data from the UFS device controller to the at least one processor, memory, including one or more storage media, storing instructions, the memory including non-volatile memory and cache memory, wherein the at least one processor is communicatively coupled to theUFS device controller and the memory, and wherein the instructions, when executed by the UFS device controller, cause the electronic device to identify that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate, based on an error identified through the UFS interface, and while the second state is maintained, after a specified time from a time point at which the change from the first state to the second state is identified, transmit the cache data stored in the cache memory to non-volatile memory.

In accordance with another aspect of the disclosure, an electronic device is provided. The electronic device includes at least one processor, a UFS device controller operatively coupled to the at least one processor, a UFS interface including a downstream lane for transmitting data from the at least one processor to the UFS device controller and an upstream lane for transmitting data from the UFS device controller to the at least one processor, and memory, including one or more storage media, storing instructions, the memory including non-volatile memory and cache memory, wherein the at least one processor is communicatively coupled to theUFS device controller and the memory, wherein the instructions, when executed by the at least one processor individually or collectively, cause the electronic device to set a reset time for releasing a communication link established with the UFS device controller based on an error identified through the UFS interface, at least temporarily refrain from requesting the UFS device controller to process data generated after a time point of identifying the error during the reset time, and wherein the instructions, when executed by the UFS device controller, cause the electronic device to identify that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate, and while the second state is maintained, after a specified time from a time point at which the change from the first state to the second state is identified, transmit cache data stored in the cache memory from the cache memory to the non-volatile memory.

In accordance with another aspect of the disclosure, a method performed by an electronic device is provided. The method includes based on an error identified through a universal flash storage (UFS) interface including a downstream lane for transmitting data from at least one processor of the electronic device to a UFS device controller and an upstream lane for transmitting data from the UFS device controller to the at least one processor, identifying that a state associated with a UFS interface is changed from a first state in which data is transmitted based on a first data processing rate through at least one of a downstream lane or an upstream lane, to a second state in which data is transmitted through at least one of the downstream lane or the upstream lane based on a second data processing rate different from the first data processing rate, and while the second state is maintained, after a specified time from a time point at which the change from the first state to the second state is identified, transmitting cache data stored in cache memory to non-volatile memory.

In accordance with another aspect of the disclosure, one or more non-transitory computer-readable storage media storing one or more computer programs including computer-executable instruction that, when executed by at least one processor of an electronic device individually or collectively, cause the electronic device to perform operations are provided. The operations include, based on an error identified through a UFS interface including a downstream lane for transmitting data from at least one processor of the electronic device to a UFS device controller and an upstream lane for transmitting data from the UFS device controller to the at least one processor, identifying that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate, and while the second state is maintained, after a specified time from a time point at which the change from the first state to the second state is identified, transmitting cache data stored in cache memory to non-volatile memory.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates a universal flash storage (UFS) system including a UFS host device and a UFS storage device according to an embodiment of the disclosure;

FIG. 2B illustrates a block diagram of storage according to an embodiment of the disclosure;

FIGS. 3A and 3B illustrate an operation of writing cache data to non-volatile memory based on a state of a UFS interface according to various embodiments of the disclosure;

FIG. 4 illustrates an operation of writing cache data to non-volatile memory in a pulse width modulation (PWM) mode according to an embodiment of the disclosure;

FIG. 5 illustrates a flowchart indicating an operation of a UFS storage device according to an embodiment of the disclosure; and

FIG. 6 illustrates a data flowchart between a UFS host device and a UFS storage device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

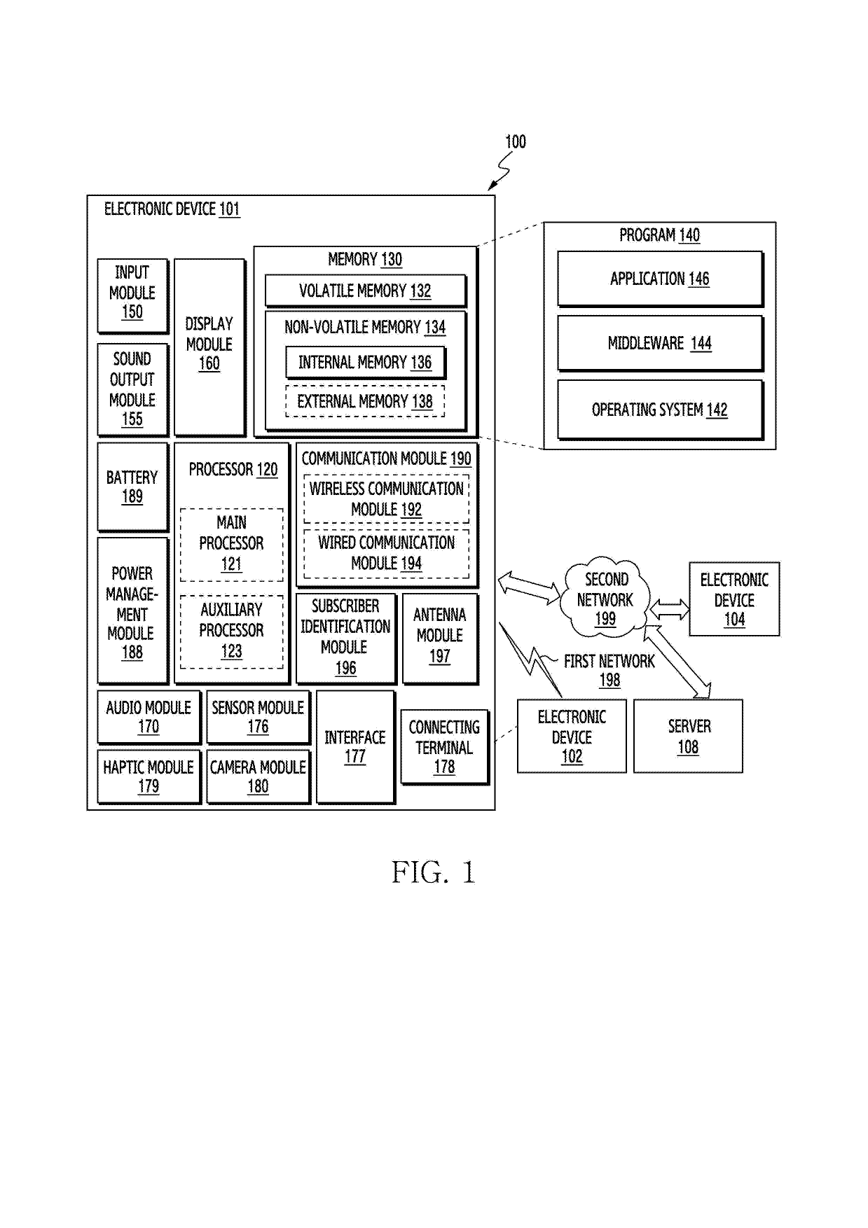

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device, according to various embodiments of the disclosure, may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as "A or B," "at least one of A and B," "at least one of A or B," "A, B, or C," "at least one of A, B, and C," and "at least one of A, B, or C," may include any one of or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," or "connected with" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

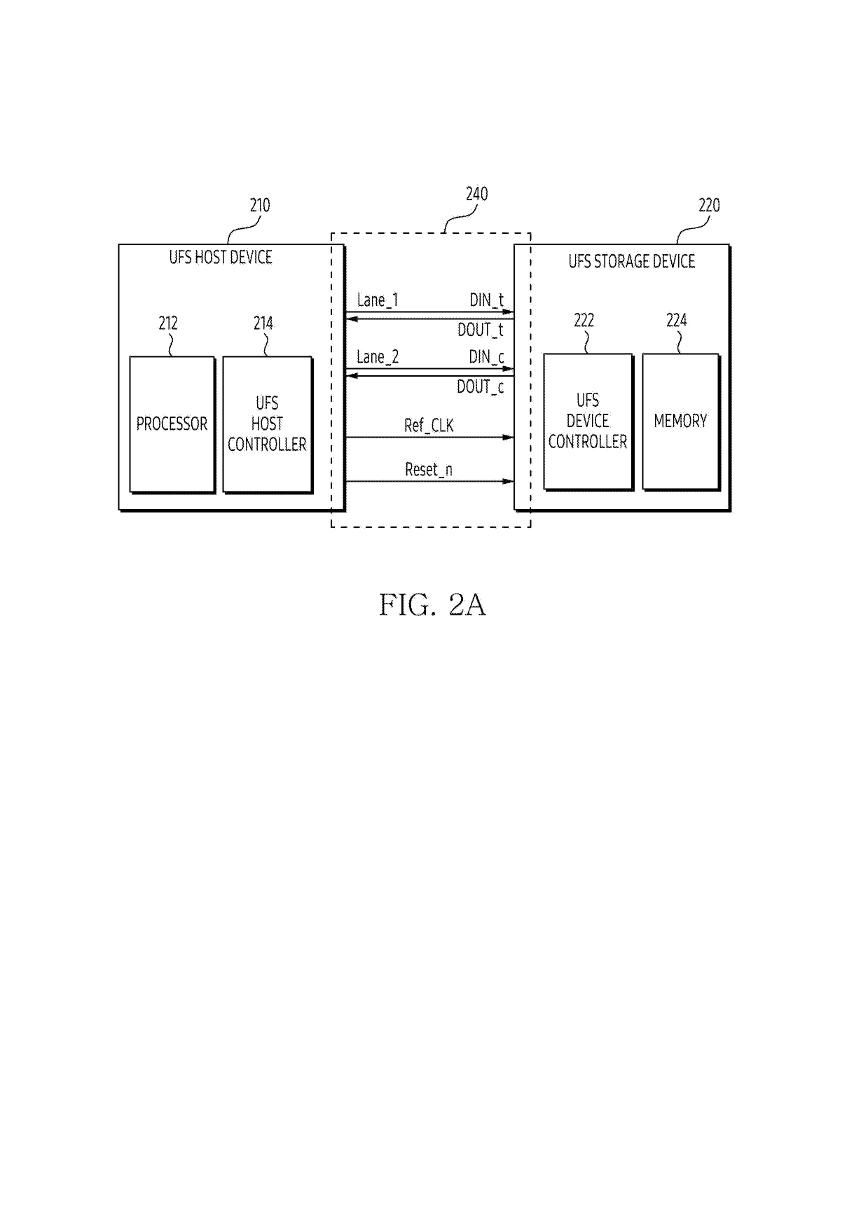

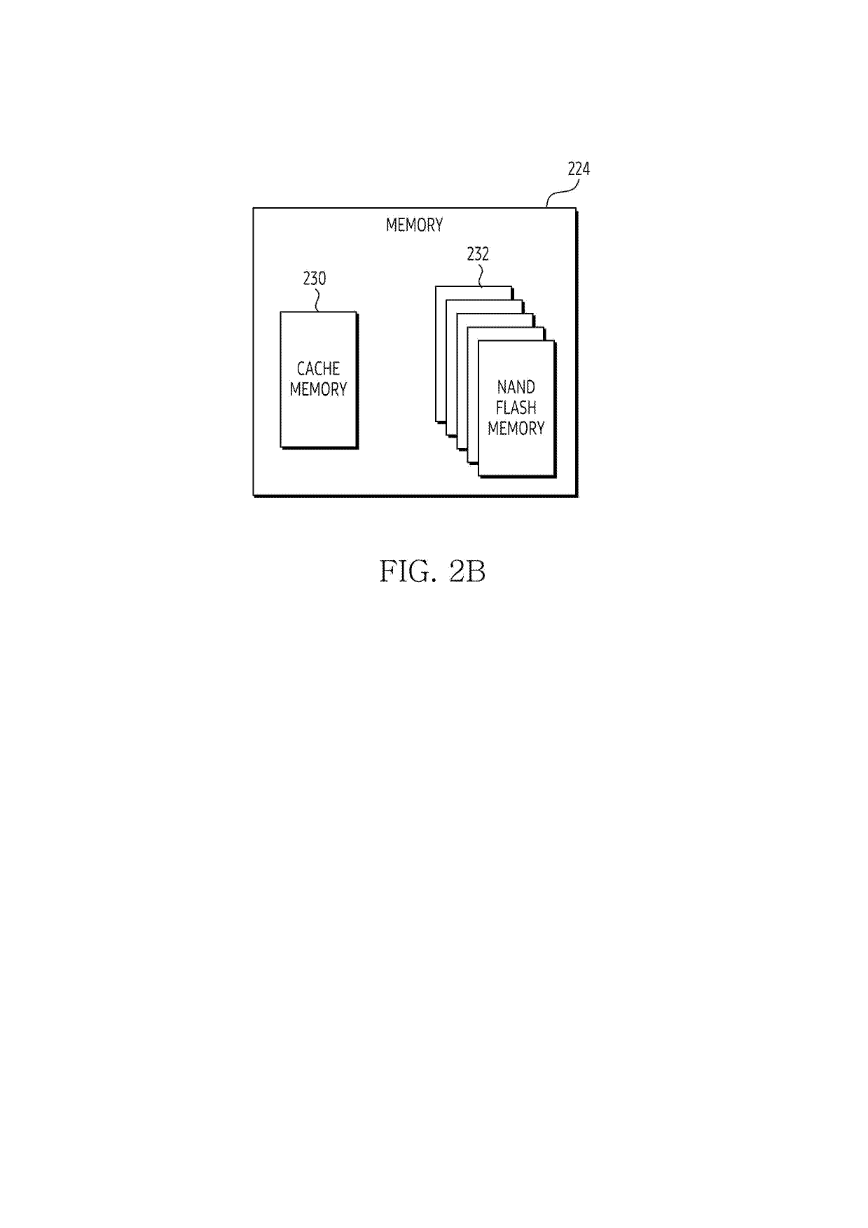

FIG. 2A illustrates a UFS system including a UFS host device and a UFS storage device according to an embodiment of the disclosure.

Referring to FIG. 2A, a UFS system 200, which is a system that follows a UFS standard published by a joint electron device engineering council (JEDEC), may include the UFS host device 210 and the UFS storage device 220. Referring to FIGS. 1 and 2A together, the UFS host device 210 may be implemented as a portion of the processor 120 of FIG. 1, or the UFS storage device 220 may be implemented as a portion of the memory 130 (e.g., the non-volatile memory 134) of FIG. 1. For example, the UFS host device 210 and the UFS storage device 220 may be included in the electronic device 101 of FIG. 1.

According to an embodiment of the disclosure, the UFS host device 210 and the UFS storage device 220 may be interconnected through a UFS interface 240. The UFS interface 240 may include a lane for transmitting a reference clock Ref_CLK, a lane for transmitting a hardware reset signal Reset_n for the UFS storage device 220, lanes for transmitting a differential input signal pair DIN_t and DIN_c, and lanes for transmitting a differential output signal pair DOUT_t and DOUT_c. The differential input signal pair DIN_t and DIN_c transmitting data from the UFS host device 210 to the UFS storage device 220 may be referred to as a downstream lane. The differential output signal pair DOUT_t and DOUT_c transmitting data from the UFS storage device 220 to the UFS host device 210 may be referred to as an upstream lane. The UFS interface 240 may include a mobile industry processor interface (MIPI) Unified Protocol (UniPro) and/or MIPI M-PHY. The UFS interface 240 may include a differential dual simplex physical layer. The UFS interface 240 may be referred to as an M-PHY interface, a UFS interconnect (UIC), a UniPro interface, and/or a link.

For example, the UFS host device 210 and the UFS storage device 220 interconnected through the UFS interface 240 may transmit or receive data based on a gear speed. The gear speed may refer to a data rate, which is a speed at which a first lane Lane_1 and/or a second lane Lane_2 transmits data. For example, the gear speed may be divided into a pulse width modulation (PWM) gear with a low data rate and a high speed (HS) gear with a high data rate. The PWM gear supported by the UFS host device 210 and the UFS storage device 220 may include a PWM-G1 gear of 3 Mbps to 9 Mbps. The HS gear may be divided into five stages of gear speeds. For example, the HS gear may be divided into 1248 Mbps HS-GEAR 1, 2496 Mbps HS-GEAR 2, 4992 Mbps HS-GEAR 3, 9984 Mbps HS-GEAR 4, and 19968 Mbps HS-GEAR 5.

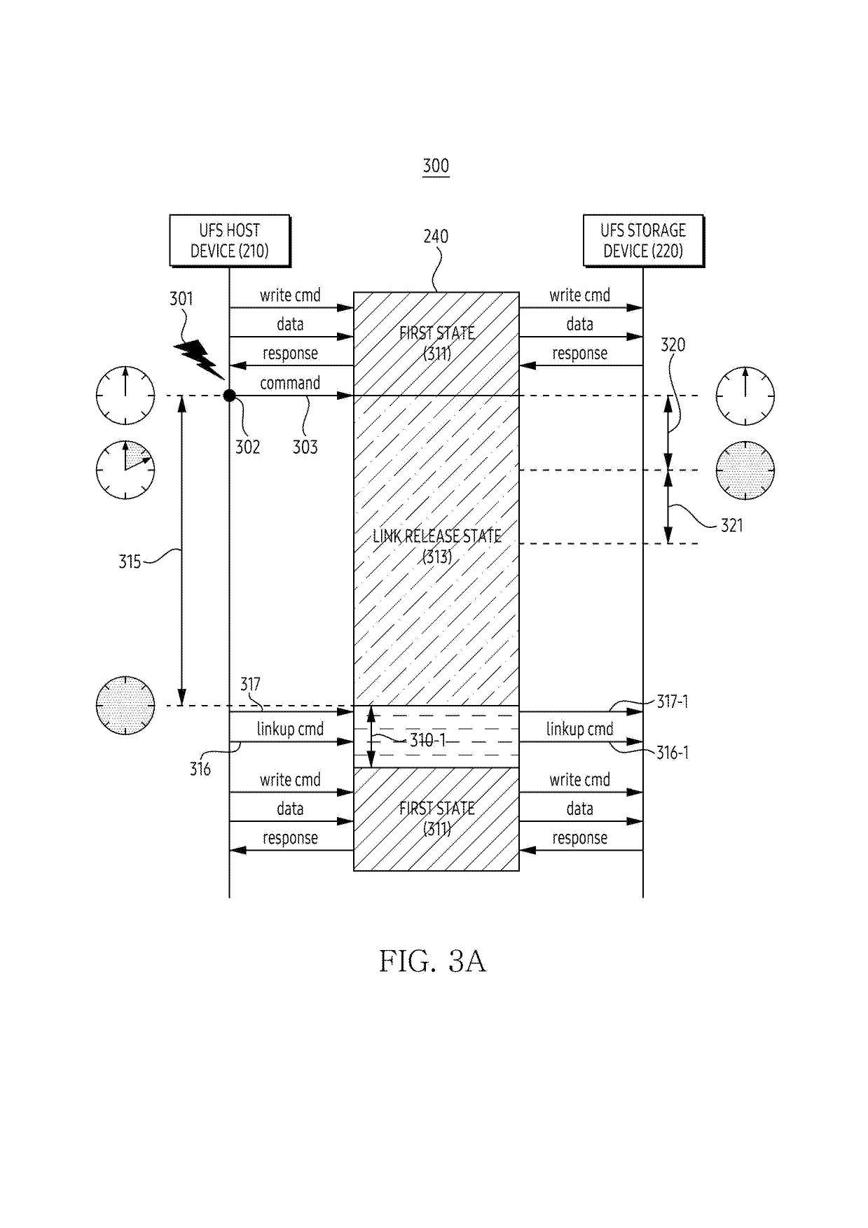

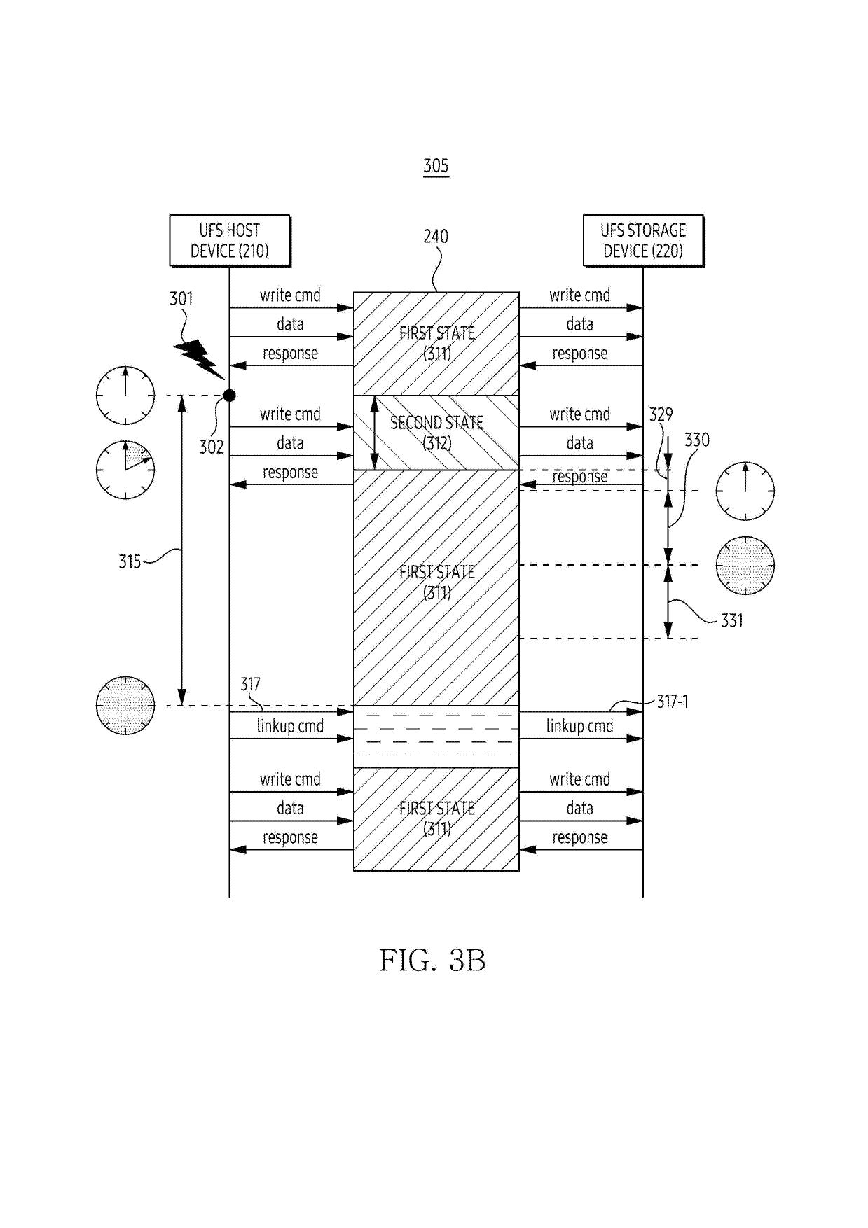

For example, a state associated with the UFS interface 240 may be changed based on the gear speed. In a case of transmitting and receiving data based on the HS gear, the state may be referred to as an HS state, an HS mode, a data transmission mode, an active mode, and/or a first state. In a case of transmitting and receiving data based on the PWM gear, the state may be referred to as a PWM mode, an initialization mode, a control mode, a recovery mode, a low power mode, an idle state, and/or a second state. For example, a first data processing rate for processing data through the UFS interface 240 based on the first state (a first state 311 of FIG. 3B) may be faster than a second data processing rate for processing data through the UFS interface 240 based on the second state (e.g., a second state 312 of FIG. 3B).

For example, when establishing a communication link between the UFS host device 210 and the UFS storage device 220, the UFS interface 240 may transmit or receive data based on the PWM gear for a specified time, and may transmit or receive data based on the HS gear after the specified time. However, it is not limited thereto. For example, the state associated with the UFS interface 240 may be changed from the HS mode to the PWM mode in a case that an error is identified.

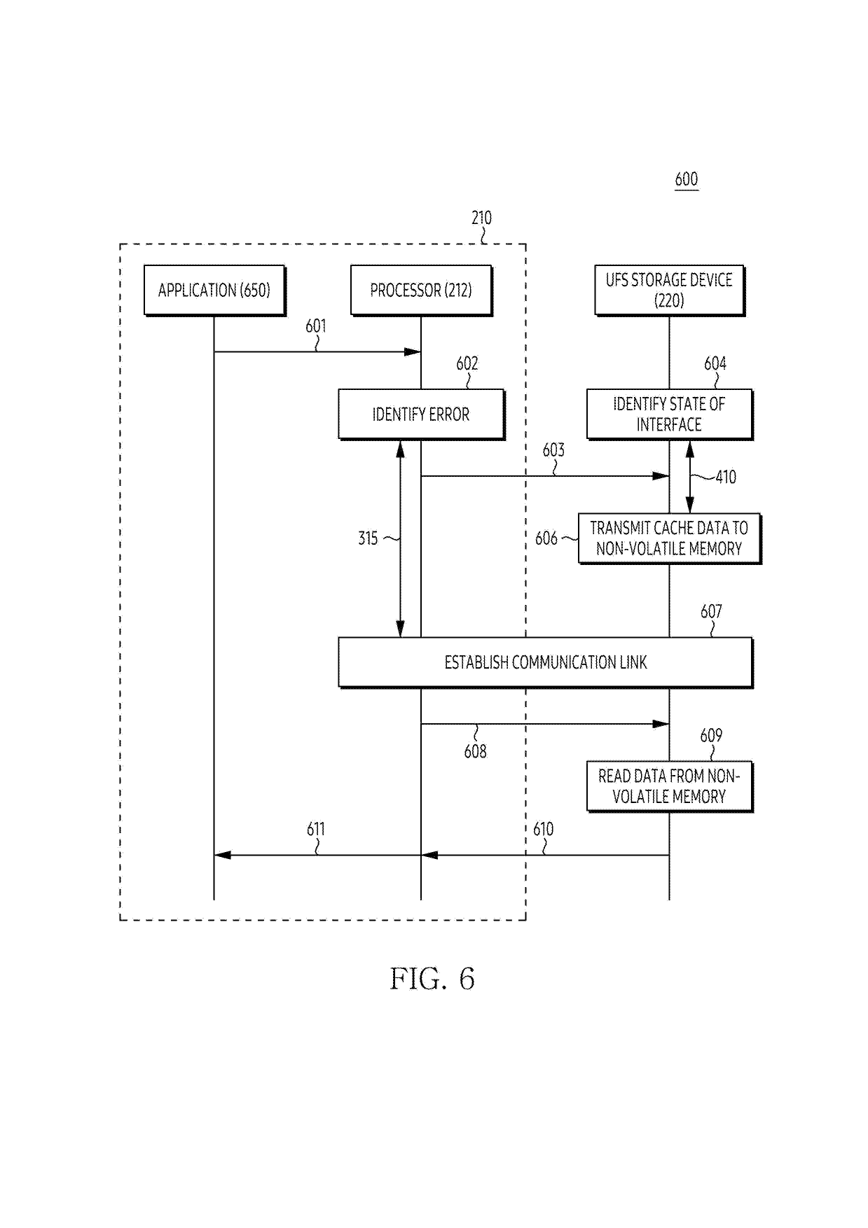

The UFS host device 210, according to an embodiment of the disclosure, may include a processor 212 and a UFS host controller 214. The processor 212 of the UFS host device 210 may correspond to the main processor 121 (e.g., an application processor) of FIG. 1. The processor 212 may execute a program (e.g., an application 650 of FIG. 6) that desires communication with the UFS storage device 220. The processor 212 may control the UFS host controller 214 through a host controller interface (UFS-HCI). For example, an input/output request of the processor 212 may be converted into UFS commands specified in the UFS standard through a UFS driver (not illustrated), and the converted UFS commands may be transmitted to the UFS host controller 214. The UFS host controller 214 may transmit the converted UFS commands to the UFS storage device 220 through the UFS interface.

The UFS storage device 220, according to an embodiment of the disclosure, may include a UFS device controller 222 and memory 224. The UFS device controller 222 may receive a command from the UFS host device 210 and read user data from the memory 224 according to the received command and provide it to the UFS host device 210, or program (or write) user data provided from the UFS host device 210 into the memory 224.

The memory 224, according to an embodiment of the disclosure, may be a non-volatile storage device that stores data regardless of whether power is supplied. The memory 224 may include non-volatile memories that store data under a control of the UFS device controller 222. For example, the non-volatile memory may include NAND flash memory, but is not limited thereto. According to various embodiments of the disclosure, the memory 224 may also include another type of non-volatile memory, such as phase-change random access memory (PRAM) and/or resistive random access memory (RRAM).

FIG. 2B illustrates a block diagram of memory according to an embodiment of the disclosure.

Referring to FIG. 2B, the memory 224 may include cache memory 230 and a plurality of NAND flash memories 232.

For example, the cache memory 230 may temporarily store write data received from a UFS host device 210. The cache memory 230 may be buffer memory for a write boost defined in a UFS standard. For example, the cache memory 230 may correspond to single level cell (SLC) flash memory. The SLC flash memory may be flash memory configured to store 1 bit for each unit cell. The cache memory 230 may include at least one of dynamic RAM (DRAM), static RAM (SRAM), Cache RAM, and pseudo SRAM (PSRAM).

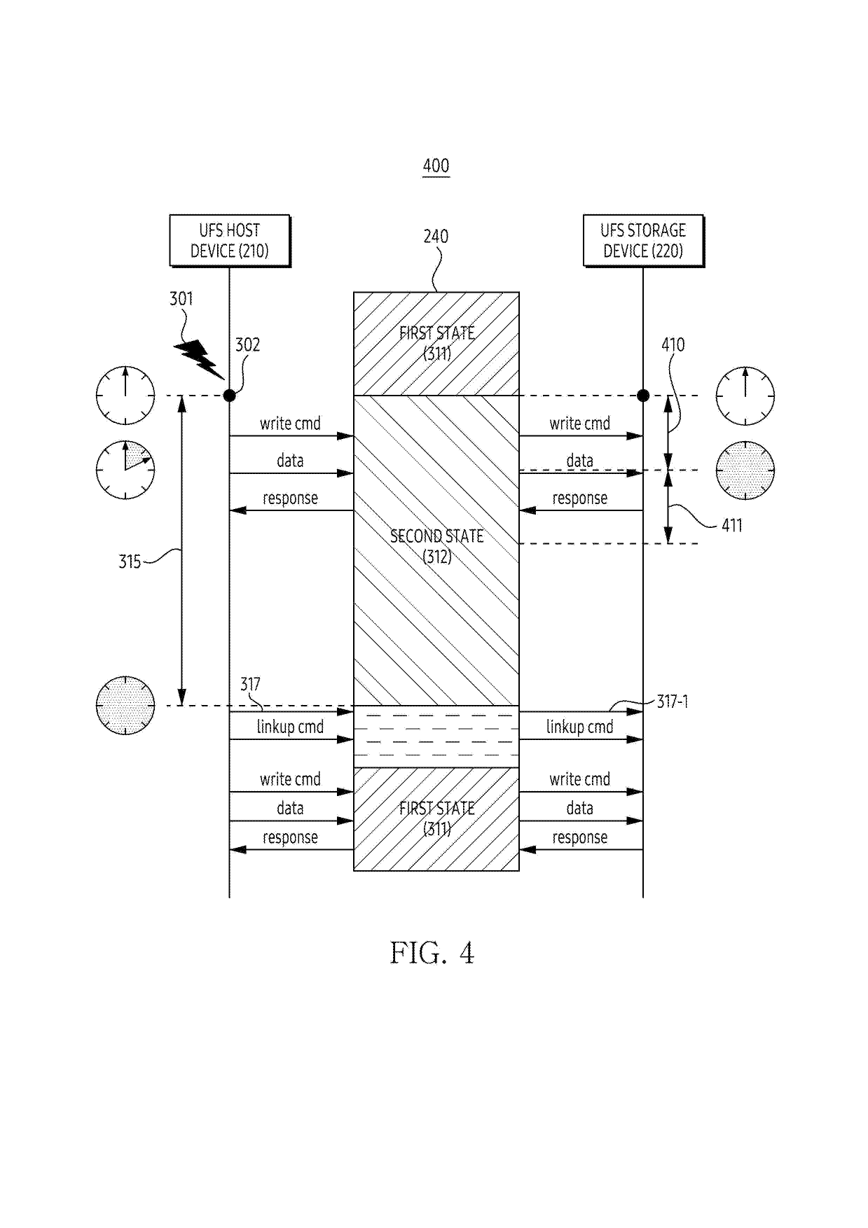

For example, cache data temporarily stored in the cache memory 230 may be deleted according to whether power is supplied, or by a hardware reset or a software reset. A UFS host controller 214 may transmit a UFS command for reducing a loss of cache data to a UFS device controller 222 through a UFS interface 240. The UFS device controller 222 may flush the cache data temporarily stored in the cache memory 230 to at least one of the plurality of NAND flash memories 232, before the cache data is deleted. An example of an operation for flushing the cache data to at least one of the plurality of NAND flash memories 232 will be described later with reference to FIG. 4.

For example, the plurality of NAND flash memories 232, which are a non-volatile storage device that stores data even when a power supply is cut off, may have a relatively larger storage capacity compared to the cache memory 230. The plurality of NAND flash memories 232 may be flash memory configured to store at least 2 bits for each unit cell. For example, the plurality of NAND flash memories 232 may include any one of a single level cell (SLC), a multi level cell (MLC), a triple level cell (TLC), and a quadruple level cell (QLC). The plurality of NAND flash memories 232 may be included in the non-volatile memory 134 of FIG. 1.

According to an embodiment of the disclosure, cache data stored in the cache memory 230 may be stored in the plurality of NAND flash memories 232 according to a control of the UFS device controller 222. In a case that a state of the UFS interface 240, which is a second state (e.g., a PWM mode), is maintained, the UFS device controller 222 may transmit cache data to the plurality of NAND flash memories 232 prior to initialization of the UFS host device 210. The UFS device controller 222 may at least partially reduce the loss of cache data based on transmitting the cache data to the plurality of NAND flash memories 232.

Hereinafter, an example of an operation of flushing the cache data stored in the cache memory 230 before reestablishing a communication link between the UFS host device 210 and a UFS storage device 220 by an error identified through the UFS interface 240 will be described later with reference to FIGS. 3A and 3B.

FIGS. 3A and 3B illustrate an operation of writing cache data to non-volatile memory based on a state of a UFS interface according to various embodiments of the disclosure.

A UFS host device 210 of FIGS. 3A and 3B may be referred to the UFS host device 210 of FIG. 2A. A UFS storage device 220 of FIGS. 3A and 3B may be referred to the UFS storage device 220 of FIG. 2A.

Referring to FIG. 3A, a state 300 including the UFS host device 210 and the UFS storage device 220 that transmit and receive data through the UFS interface 240 is illustrated.

According to an embodiment of the disclosure, the UFS host device 210 and the UFS storage device 220 may transmit or receive data through the UFS interface 240 based on a first state 311. For example, the UFS host device 210 may transmit a UFS command to write data in the UFS storage device 220 (or the plurality of NAND flash memories 232 of FIG. 2B) to the UFS storage device 220 through the UFS interface 240. For example, the UFS storage device 220 may store (or write) a UFS command and data in at least one of the plurality of NAND flash memories. After storing the data, the UFS storage device 220 may transmit a data signal indicating a response to the UFS host device 210 through the UFS interface 240. The data signal may indicate a complete response to storage of the data.

For example, the UFS host device 210 and the UFS storage device 220 may identify an error 301 occurring in the UFS interface 240. The error 301 may occur in at least one case among a case that NAND flash memories (or a memory cell) are damaged, a case that data stored in the UFS storage device 220 is damaged, a case that a UFS device controller 222 is damaged, and/or a case that a communication link between the UFS host device 210 and the UFS storage device 220 is released. However, it is not limited thereto. For example, the error 301 may include a case that an error occurs in MIPI M-PHY (e.g., a protocol associated with the UFS interface 240) and data may not be transmitted or received normally, and/or a case that the number of error bits included in the data increases. For example, a state of the UFS interface 240 may be changed based on a type of the error 301.

For example, a state associated with the UFS interface 240 may enter from the first state 311 into a link release state 313 in which the communication link between the UFS host device 210 and the UFS storage device 220 is released by the error 301 identified through the UFS interface 240. The link release state 313 may indicate a state in which the UFS interface 240 is deactivated. In a case that the error 301 occurs, transmission of a UFS command 303 from the UFS host device 210 to the UFS storage device 220 through the UFS interface 240 may be at least temporarily refrained. Since data may not be transmitted through the UFS interface 240 based on the link release state 313, data may be pended in the UFS host device 210.

For example, the UFS host device 210 may set a reset time 315 (or a delay time or a flush time) (e.g., approximately 2 seconds) for establishing the communication link with the UFS storage device 220 from a time point 302 at which the error 301 is identified. The UFS storage device 220 may set an idle time 320 (e.g., approximately 300 ms) based on identifying a state of the UFS interface 240 entering the link release state 313 based on the error 301. The idle time 320 may be set based on identifying the link release state 313 by the UFS storage device 220. The UFS storage device 220 may identify that reception of data from the UFS host device 210 is temporarily ceased during the idle time 320 from the time point 302. The UFS storage device 220 may flush cache data temporarily stored in cache memory to non-volatile memory after the idle time 320 from the time point 302. The flushed cache data may be stored in the non-volatile memory, and information temporarily stored in the cache memory may be deleted after the reset time 315. For example, the UFS storage device 220 may transmit cache data to the non-volatile memory during a flush time period 321 before the reset time 315 elapses from the time point 302. The UFS storage device 220 may flush cache data to the non-volatile memory in a background. The background may refer to the UFS device controller 222 performing independently of the UFS host device 210. For example, the UFS device controller (e.g., the UFS device controller 222 of FIG. 2A) may transmit cache data to the non-volatile memory even when not receiving a separate command from the UFS host device 210.

For example, the UFS host device 210 may transmit a UFS command 316 (e.g., a linkup cmd of FIG. 3A) for establishing the communication link between the UFS host device 210 and the UFS storage device 220 to the UFS storage device 220 through the UFS interface 240 after the reset time 315 passes from the time point 302. For example, a state associated with the UFS interface 240 during a link establishment period 310-1 may correspond to a PWM state. For example, before transmitting the UFS command 316, the UFS host device 210 may transmit a UFS command 317 (e.g., a hardware reset signal) for initializing the cache memory.

For example, the UFS storage device 220 may initialize the cache memory based on receiving a UFS command 317-1. Since the cache data stored in the cache memory has been flushed to the non-volatile memory after the idle time 320 having a shorter time than the reset time 315 is completed, the UFS storage device 220 may reduce a loss of the cache data. Hereinafter, an example of an operation of the UFS host device 210 and the UFS storage device 220, which successfully changed from a second state 312 to a first state 311 after the error 301 occurs, will be described with reference to FIG. 3B. For example, after initializing the cache memory, the UFS storage device 220 may establish the communication link with the UFS host device 210 as a response with respect to a UFS command 316-1.

Referring to FIG. 3B, a state 305 in which the state associated with the UFS interface 240 has been changed from the first state 311 to the second state 312 based on the error 301 identified through the UFS interface 240 is illustrated.

For example, the first state 311 may include a state of the UFS interface 240 for transmitting data based on a first data processing rate through at least one of a downstream lane and an upstream lane. The first data processing rate may be set based on an HS gear. The second state 312 may include a state for transmitting data through at least one of the downstream lane and the upstream lane based on a second data processing speed. The second data processing rate may be set based on a PWM gear. The second data processing rate may be slower than the first data processing rate. The first state 311 may be referred to as an HS mode, an HS state and/or a data transmission mode, and an active mode. The second state 312 may be referred to as a PWM mode, a PWM state, an initialization mode, a control mode, and/or a recovery mode.

For example, the UFS host device 210 may identify that the state associated with the UFS interface 240 is changed from the first state 311 to the second state 312 at the time point 302 at which the error 301 occurs. The UFS host device 210 may idle during the reset time 315 for releasing the communication link between the UFS host device 210 and the UFS storage device 220 from the time point 302 at which the error 301 occurs. While the reset time elapses, the UFS host device 210 may not transmit a request generated after the time point 302 to the UFS storage device 220.

For example, the UFS storage device 220 may identify a state of the UFS interface 240 entering the second state 312 from the time point 302 at which the error 301 occurs. The UFS storage device 220 may identify the second state 312 based on determining that data is received based on the second data processing rate corresponding to the second state 312.

For example, in a case that noise caused by the error 301 disappears before the reset time 315 elapses from the time point 302 (e.g., a temporary impact), the UFS host device 210 may change the state of the UFS interface 240 from the second state 312 to the first state 311. For example, the UFS interface 240 may change from the second state 312 to the first state 311 in a background state, independently of a command received from the UFS host device 210. However, it is not limited thereto.

For example, the UFS storage device 220 may process pended data based on identifying the state of the UFS interface 240 changed from the second state 312 to the first state 311. In a case that the error 301 occurs while processing data requested before the time point 302, the UFS storage device 220 may process the data based on the second data processing rate corresponding to the second state 312. Since the second data processing rate is slower than the first data processing rate, the processing of the data requested before the time point 302 may be delayed. The UFS storage device 220 may process the delayed data based on the first data processing rate after being changed to the first state 311. In a viewpoint requested from the UFS host device 210 to the UFS storage device 220 before the time point 302, the delayed data may include pending data, whose processing has been suspended for a specified time. For example, the delayed data may include data at least temporarily stored in the cache memory for transmission to the UFS host device 210 after processing is completed. For example, the delayed data may include data stored in the cache memory before being stored in the non-volatile memory, after the UFS storage device 220 receives a command (e.g., a command).

For example, the UFS storage device 220 may set an idle time 330 for identifying whether a UFS command is received from the UFS host device 210 after a time period 329 during which entire pended data is processed. The idle time 330 may be set based on the entire pended data being processed. In a case that the UFS command is not received while the idle time 330 elapses, the UFS storage device 220 may infer an occurrence of the error 301. In a case that the UFS command is not received while the idle time 330 elapses, the UFS storage device 220 may infer a reset by the UFS host device 220. The UFS storage device 220 may flush cache data to the non-volatile memory in order to reduce a loss of the cache data stored in the cache memory by the reset. For example, after the idle time 330, the UFS storage device 220 may transmit the entire cache data stored in the cache memory to the non-volatile memory for a time period 331. The transmitted cache data may be preserved independently from initialization of the cache memory by being stored in the non-volatile memory.

For example, in a case that noise is periodically generated based on the type of the error 301, a state of the UFS interface 240, which is the second state 312, may be maintained. Since the pended data is processed based on the second data processing rate in the second state 312, the UFS storage device 220 may refrain from setting the idle time 330. In a case that the idle time 330 is not set, it may be deleted since cache data stored in the cache memory may not be flushed to the non-volatile memory during the reset time 315. Since the idle time 320 may be set in a case that the link release state 313 is identified and the idle time 330 may be set in a case that the entire pended data is processed, the UFS storage device 220 may set a PWM time to flush the cache data to the non-volatile memory even when the second state 312 is maintained. Hereinafter, an example of an operation of the UFS storage device 220 for setting the PWM time will be described later with reference to FIG. 4.

FIG. 4 illustrates an operation of writing cache data to non-volatile memory in a PWM mode according to an embodiment of the disclosure.

Referring to FIG. 4, a state 400 in which the PWM mode (e.g., the second state 312) is maintained after an error 301 occurs is illustrated. A UFS host device 210 of FIG. 4 may include the UFS host device 210 of FIGS. 2A, 2B, 3A and 3B. A UFS storage device 220 of FIG. 4 may include the UFS storage device 220 of FIGS. 2A, 2B, 3A, and 3B.

Referring to FIG. 4, the UFS host device 220, according to an embodiment of the disclosure, may set a reset time 315 based on the error 301 identified through a UFS interface 240. The UFS host device 220 may at least temporarily refrain from transmitting requests generated after a time point 302 at which the error 301 occurs. For example, a UFS command (e.g., a write cmd) transmitted by the UFS host device 210 through the UFS interface 240 after the time point 302 at which the error 301 occurs may be transmitted based on a request generated before the time point 302. However, it is not limited thereto.

The UFS storage device 220, according to an embodiment of the disclosure, may identify, based on the error 301 identified through the UFS interface 240, that a state associated with the UFS interface 240 has been changed from a first state 311 for transmitting data through at least one of a downstream lane and an upstream lane based on a first data processing rate to a second state 312 for transmitting data through at least one of the downstream lane and the upstream lane based on a second data processing rate. The UFS storage device 220 may identify the second state 312 based on data pended in the UFS host device 210 being transmitted through the UFS interface 240 based on the second data processing rate. The UFS storage device 220 may identify the second state 312 by receiving an interrupt signal indicating a change from the first state 311 to the second state 312 from the UFS host device 210 through the UFS interface 240. Independently, the change may be identified based on data (or a UFS command) being transmitted based on the second data processing rate, through at least one of the upstream lane or the downstream lane, for an identification time shorter than a PWM time 410 (e.g., approximately 300 ms). However, it is not limited thereto. For example, in a case that the UFS host device 210 receives an interrupt signal indicating that the state associated with the UFS interface 240 is changed from the first state 311 to the second state 312 after the error 301 occurs, the UFS storage device 220 may identify the second state 312. For example, the second state 312 may be identified by a UFS device controller in the UFS storage device 220.

For example, the UFS storage device 220 may set the PWM time 410 for identifying whether to process cache data stored in cache memory from a time point at which the change from the first state 311 to the second state 312 is identified while the second state 312 is maintained based on identifying the second state 312. The UFS storage device 220 may transmit (or flush) the cache data from the cache memory to the non-volatile memory after the PWM time 410 has elapsed. For example, the UFS storage device 220 may perform the operation of FIG. 3B in a case of being changed from the second state 312 to the first state 311 before the PWM time 410 elapses. As an example, the UFS storage device 220 may process at least a portion of cache data based on the first state 311. As an example, the UFS storage device 220 may set an idle time 330 based on processing at least a portion of the cache data after being changed to the first state 311.

For example, the UFS storage device 220 may at least temporarily cease flushing cache data in a case that the error 301 is at least temporarily corrected before the PWM time 410 elapses. However, it is not limited thereto.

For example, in a case that the UFS storage device 220 does not receive a UFS command from the UFS host device 210 while the PWM time 410 elapses from a time point at which the change is identified, it may infer a reset due to the error 301. The UFS storage device 220 may set the PWM time 410 for writing the cache data to the non-volatile memory in order to prevent the cache data from being deleted in the cache memory by the reset.

For example, the UFS storage device 220 may process the cache data (e.g., a pending request) in the cache memory during the PWM time 410. After the PWM time 410, the UFS storage device 220 may at least temporarily cease processing the cache data and transmit the cache data to the non-volatile memory.

For example, the UFS storage device 220 may write the cache data to the non-volatile memory after the PWM time 410 has elapsed. The UFS storage device 220 may at least temporarily refrain from writing to the cache data in the cache memory after the PWM time 410. The UFS storage device 220 may write pended delayed data to the non-volatile memory without writing to the cache memory based on identifying completion of the PWM time 410 while processing the pended delayed data (e.g., a pending request).

For example, the UFS host device 210 may identify the reset time 315 for releasing a communication link established with the UFS device controller (or the UFS storage device 220) based on identifying the error 301 through the UFS interface 240. The UFS host device 210 identifying the reset time 315 may include setting a parameter corresponding to the reset time or identifying the set parameter. The UFS host device 210 may measure a time based on the reset time 315 by identifying the reset time 315. The UFS host device 210 may release the communication link after the reset time 315. The PWM time 410 (e.g., 300 ms) may be shorter than the reset time 315 (e.g., 2 seconds). The UFS host device 210 may at least temporarily refrain from requesting the UFS device controller (or the UFS storage device 220) to process data generated after the time point 302 at which the error 301 is identified, during the reset time 315. Since the UFS host device 210 at least temporarily refrains from requesting processing of the data generated after the time point 302, data pended in the UFS storage device 220 processed after the time point 302 may include data requested from the UFS host device 210 before the time point 302. The UFS host device 210 may release and re-establish the communication link with the UFS storage device 220 after the reset time 315 from the time point 302. The operation of releasing and re-establishing the communication link may be referred to as a reset operation of the communication link.

For example, the UFS host device 210 may transmit to the UFS storage device 220 a data signal (e.g., a UFS command) requesting read of the cache data stored in the non-volatile memory based on the first data processing rate based on the UFS interface 240 based on the first state 311 via a communication link established after the reset time 315. The data signal may indicate a re-request for data in a case that the UFS host device 210 does not receive a response to the data (e.g., data write or data read) requested before the error occurrence time point 302. The cache data stored in the non-volatile memory may include data stored in the cache memory of the UFS storage device 220 and stored in the non-volatile memory after the PWM time 410 by a UFS command requesting to write data transmitted from the UFS host device 210 before the error occurrence time point 302.

The UFS storage device 220, according to an embodiment of the disclosure, may flush the cache data stored in the cache memory to the non-volatile memory after the PWM time 410 shorter than the reset time 315 has elapsed during the reset time 315.

For example, after identifying the error 301, the UFS storage device 220 may identify a time to flush the cache data stored in the cache memory based on a state of the UFS interface 240 due to the error 301. The UFS storage device 220 may store time information indicating a time based on the state in memory. The time information may include information indicating the idle time 320 of FIG. 3A, the idle time 330 of FIG. 3B, and/or the PWM time 410 of FIG. 4. The UFS storage device 220 may identify a time for transmitting the cache data into the non-volatile memory according to the state of the UFS interface 240 due to the error 301.

As described above, since the UFS storage device 220, according to an embodiment of the disclosure, may not process the entire pended data based on the second data processing rate corresponding to the second state 312, the idle time 330 of FIG. 3B may not be set. In a case that the idle time 330 is not set, a problem that the cache data stored in the cache memory is deleted after the reset time 315 has elapsed may occur. The UFS storage device 220 may preserve the cache data stored in the cache memory by setting the PWM time 410 independently of processing the entire pended data in the second state 312.

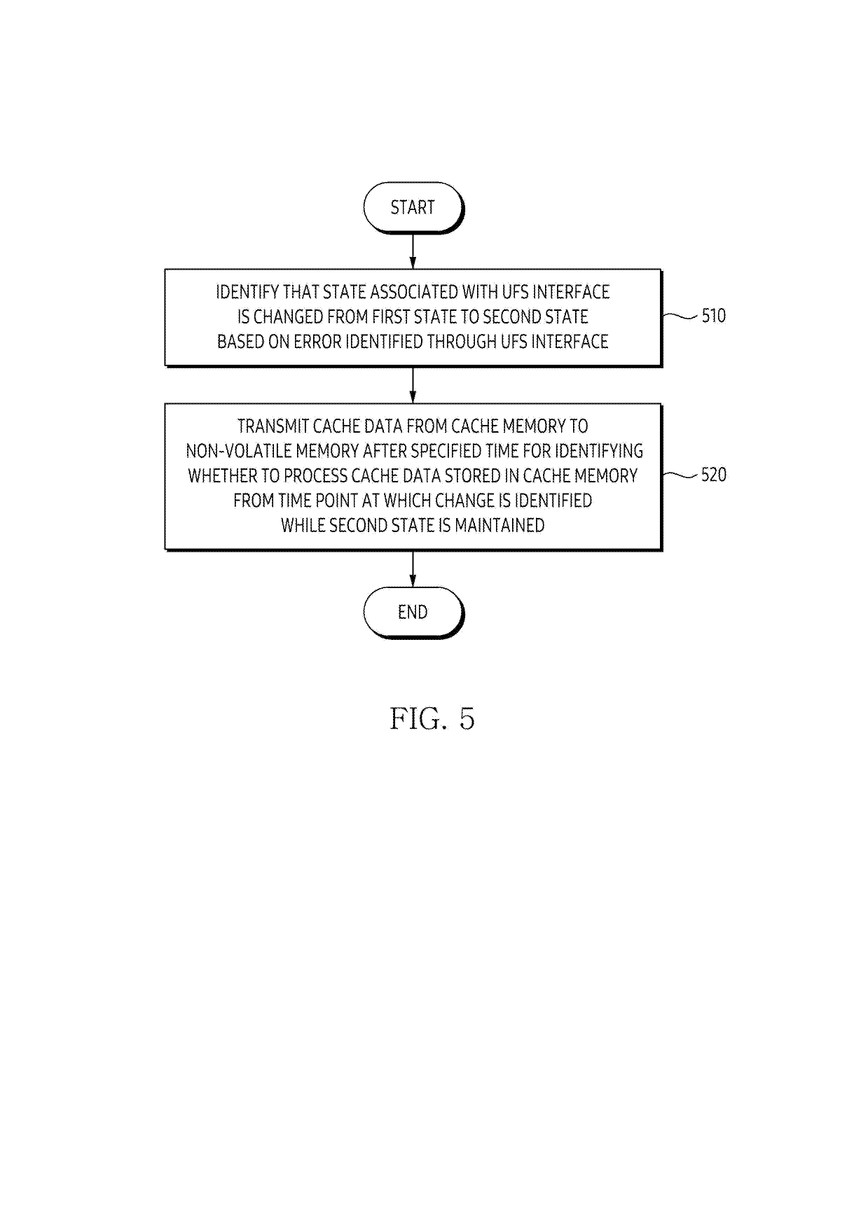

FIG. 5 illustrates a flowchart indicating an operation of a UFS storage device according to an embodiment of the disclosure.

The UFS storage device of FIG. 5 may include the UFS storage device 220 of FIGS. 2A, 2B, 3A, 3B, and 4. At least one of operations of FIG. 5 may be performed by the UFS storage device 220 of FIG. 2A. At least one of the operations of FIG. 5 may be controlled by the UFS device controller 222 of FIG. 2A. Each of the operations of FIG. 5 may also be performed sequentially, but is not necessarily performed sequentially. For example, an order of each of the operations may also be changed, and at least two operations may be performed in parallel.

Referring to FIG. 5, in an operation 510, a UFS device controller, according to an embodiment of the disclosure, may identify that a state associated with a UFS interface is changed from a first state to a second state based on an error identified through the UFS interface (e.g., the UFS interface 240 of FIG. 2A). The first state may be referred to the first state 311 of FIG. 3A. The second state may be referred to the second state 312 of FIG. 3B. A processor (e.g., the processor 212 of FIG. 2A) of a UFS host device (e.g., the UFS host device 210 of FIG. 2A) may identify a reset time (e.g., the reset time 315 of FIG. 3A) for releasing a communication link established with the UFS device controller based on the error identified through the UFS interface. The UFS host device may at least temporarily refrain from requesting the UFS device controller to process data generated after a time point (e.g., the time point 302 of FIG. 3A) at which the error is identified during the reset time.

For example, the UFS device controller may identify the change from the first state to the second state based on data being transmitted based on a second data processing rate through at least one of an upstream lane or a downstream lane, for an identification time shorter than a specified time (e.g., the PWM time 410 of FIG. 4). The UFS device controller may identify the change in a background, independently of receiving a separate command from the UFS host device 210.

Referring to FIG. 5, in an operation 520, while the second state is maintained, the UFS device controller, according to an embodiment of the disclosure, may transmit cache data from cache memory to non-volatile memory after the specified time for identifying whether to process the cache data stored in the cache memory from a time point at which the change is identified. The UFS device controller may set the specified time (e.g., the PWM time 410 of FIG. 4) shorter than the reset time (e.g., the reset time 315 of FIG. 3A). The UFS device controller may at least temporarily refrain from writing to the cache memory after the specified time. The UFS device controller may at least temporarily refrain (or suspend or hold) from writing to data in the cache memory after the specified time and store it in the non-volatile memory. The UFS device controller may flush the cache data from the cache memory to the non-volatile memory (e.g., the NAND flash memories 232 of FIG. 2B) after the specified time.

For example, the UFS host device may release a communication link between the UFS host device and the UFS storage device after the reset time. For example, via the communication link established after the reset time, the UFS host device may transmit a data signal (e.g., a UFS command) requesting read of the cache data stored in the non-volatile memory based on a first data processing rate to the UFS device controller, through the UFS interface based on the first state. The UFS device controller may read the cache data stored in the non-volatile memory. The UFS device controller may store the cache data in the cache memory and transmit a complete response signal indicating the read of the cache data to the UFS host device.

For example, the UFS device controller may be mounted in one package (e.g., the UFS storage device) together with memory (e.g., the memory 224 of FIG. 2A). The UFS storage device may be included in the electronic device 101 of FIG. 1 together with the UFS host device. However, it is not limited thereto.

FIG. 6 illustrates a data flowchart between a UFS host device and a UFS storage device according to an embodiment of the disclosure.

Referring to FIG. 6, a state 600 may be referred to the state 400 of FIG. 4. The state 600 may include a UFS host device 210 and a UFS storage device 220 interconnected through a UFS interface (e.g., the UFS interface 240 of FIG. 2A) based on a second state (e.g., the second state 312 of FIG. 3B) due to an error (e.g., the error 310 of FIG. 3A).

Referring to FIG. 6, an application 650 may mean a program (or a software application) installed in the UFS host device 210. The application 650 may write or read data stored in the UFS storage device 220 through a processor 212.

The processor 212 in the UFS host device 210, according to an embodiment of the disclosure, may process data 601 requesting a write from the application 650 into the UFS storage device 220. The UFS host device 210 may convert the data 601 into a UFS command 603 and transmit it to the UFS storage device 220 through the UFS interface. For example, the UFS host device 210 may transmit the UFS command 603 before performing an operation 602. According to an embodiment of the disclosure, the UFS host device 210 may transmit the UFS command 603 after performing the operation 602. Since the UFS command 603 was obtained before the processor 212 identified an error, it may be transmitted to the UFS storage device 220.

For example, in the operation 602, the processor 212 may identify the error. The error may be identified through the UFS interface. The processor 212 may set a reset time 315 for releasing a communication link based on identifying the error. The processor 212 may at least temporarily refrain from transmitting a request provided from the application 650 generated after setting the reset time 315.

In an operation 604, the UFS storage device 220, according to an embodiment of the disclosure, may identify a state of an interface based on the error identified through the UFS interface. The state of the interface (e.g., the UFS interface) may be changed from a first state to a second state. The UFS storage device 220 may set a PWM time 410 while the second state is maintained. The UFS storage device 220 may process data associated with the UFS command 603 stored in cache memory during the PWM time 410. The UFS storage device 220 may transmit cache data to non-volatile memory in an operation 606 after the PWM time 410.

For example, the UFS storage device 220 may recognize a situation in which an error has occurred after the PWM time 410. The UFS storage device 220 may process delayed data (e.g., a pending request) in parallel with flushing the cache data. For example, after the PWM time 410, the UFS storage device 220 may store the delayed data in processing in the non-volatile memory without storing it in the cache memory. However, it is not limited thereto.

For example, in a case that the UFS storage device 220 does not set the PWM time 410, since a second data processing rate corresponding to the second state is slower than a first data processing rate corresponding to the first state, the processing of the data associated with the UFS command 603 may not be completed. For example, in a case that the reset time 315 has passed while the processing of the data is not completed, the data stored in the cache memory may be deleted. In other words, the UFS storage device 220 may at least partially reduce a loss of the cache data stored in the cache memory by setting the PWM time 410 based on identifying the UFS interface based on the second state (e.g., a PWM mode).

The processor 212, according to an embodiment of the disclosure, may establish a communication link through the UFS interface with the UFS storage device 220 in an operation 607 after the reset time 315. The cache memory of the UFS storage device 220 may be initialized by a hardware reset command (e.g., the UFS command 317 of FIG. 3A) based on establishing the communication link.

For example, the processor 212 may transmit a UFS command 608 to the UFS storage device 220 through the UFS interface. The UFS command 608 may include a UFS command for requesting a response signal again in a case that the processor 212 does not receive the response signal to a write request of the data 601. The UFS command 608 may include a UFS command indicating a request generated after the operation 602.

For example, based on receiving the UFS command 608, the UFS storage device 220 may read data from the non-volatile memory in an operation 609. For example, the data may indicate data associated with the UFS command 608. Since the UFS storage device 220 flushes the cache data stored in the cache memory to the non-volatile memory, the UFS storage device 220 may read cache data corresponding to the data 601. For example, since the UFS storage device 220 flushes the cache data stored in the cache memory to the non-volatile memory, the UFS storage device 220 may transmit a response signal indicating completion of a write of the cache data corresponding to the data 601 to the UFS host device 210. For example, since the UFS storage device 220 stored a pending request (e.g., a command corresponding to pending data) in the non-volatile memory without storing it in the cache memory in parallel with a cache flush, the UFS storage device 220 may transmit the response signal indicating completion of the write of data corresponding to the data 601 to the UFS host device 210. The UFS storage device 220, according to an embodiment of the disclosure, may transmit a response signal 610 for the UFS command 608 to the UFS host device 210. For example, based on receiving the response signal 610, the processor 212 may generate data 611 indicating the response signal 610 such that it may be processed by the application 650. The UFS host device 210 may identify completion of the write request of the data 601 by processing the data 611 based on execution of the application 650.

As described above, in a case that the UFS storage device 220 does not set the PWM time 410, the UFS storage device 220 may fail to transmit a response signal for the write of the cache data, as the cache data corresponding to the data 601 is deleted. In a case that the UFS host device 210 does not receive the response signal, the UFS host device 210 may identify a time-out error. In other words, the UFS storage device 220 may normally process the write request requested by the application 650 by setting the PWM time 410 after identifying the error.

The UFS storage device, according to an embodiment of the disclosure, may preserve cache data based on writing the cache data stored in the cache memory to the non-volatile memory in the PWM mode. A method for setting a PWM time for preserving cache data by the UFS storage device in the PWM mode may be required.

An electronic device 101, according to an embodiment of the disclosure as described above, may include at least one processor 212, a universal flash storage (UFS) device controller 222 operatively coupled to the at least one processor, a UFS interface 240 including a downstream lane for transmitting data from the at least one processor to the UFS device controller and an upstream lane for transmitting data from the UFS device controller to the at least one processor, and storage 220 including non-volatile memory 232 and cache memory 230. The UFS device controller may be configured to identify that a state associated with the UFS interface is changed from a first state 311 in which data is transmitted based on a first data processing rate through at least one of the downstream lane and the upstream lane, to a second state 312 in which data is transmitted through at least one of the downstream lane and the upstream lane based on a second data processing rate different from the first data processing rate, based on an error 301 identified through the UFS interface. The UFS device controller may be configured to, while the second state is maintained, after a specified time 410 from a time point at which the change from the first state to the second state is identified, transmit cache data stored in the cache memory from the cache memory to the non-volatile memory.

For example, the UFS device controller may be configured to, after the specified time for identifying whether to process cache data stored in the cache memory, at least temporarily refrain from writing to the cache memory.

For example, the at least one processor may be configured to identify a reset time 315 for releasing a communication link established with the UFS device controller based on identifying the error through the UFS interface. The at least one processor may be configured to release the communication link after the reset time.

For example, the UFS device controller may be configured to set the specified time shorter than the reset time for releasing the communication link connected to the at least one processor through the UFS interface based on the error.

For example, the at least one processor may be configured to at least temporarily refrain from requesting the UFS device controller to process data generated after a time point 302 of identifying the error during the reset time.

For example, the UFS device controller may be configured to identify data transmitted based on the second data processing rate through at least one of the upstream lane and the downstream lane for an identification time shorter than the specified time, independently of receiving a data signal indicating the change from the first state to the second state through the UFS interface from the at least one processor. The UFS device controller may be configured to identify the change from the first state to the second state based on identifying the transmitted data.

For example, the first data processing rate may be faster than the second data processing rate.

An electronic device 101, according to an embodiment of the disclosure as described above, may include at least one processor, a universal flash storage (UFS) device controller operatively coupled to the at least one processor 212, a UFS interface 240 including a downstream lane for transmitting data from the at least one processor to the UFS device controller and an upstream lane for transmitting data from the UFS device controller to the at least one processor, and storage including non-volatile memory 232 and cache memory 230. The at least one processor may be configured to identify a reset time 315 for releasing a communication link established with the UFS device controller based on an error 301 identified through the UFS interface. The at least one processor may be configured to at least temporarily refrain from requesting the UFS device controller to process data generated after a time point 302 of identifying the error during the reset time. The UFS device controller may be configured to identify that a state associated with the UFS interface is changed from a first state 311 in which data is transmitted based on a first data processing rate through at least one of the downstream lane and the upstream lane, to a second state 312 in which data is transmitted through at least one of the downstream lane and the upstream lane based on a second data processing rate different from the first data processing rate. The UFS device controller may be configured to, while the second state is maintained, after a specified time 410 from a time point at which the change from the first state to the second state is identified, transmit cache data stored in the cache memory from the cache memory to the non-volatile memory.

For example, the UFS device controller may be configured to, after the specified time for identifying whether to process the cache data stored in the cache memory, at least temporarily refrain from writing to the cache memory.

For example, the UFS device controller may be configured to write pending data of which processing is delayed for the specified time to the non-volatile memory based on completion of the specified time.

For example, the at least one processor may be configured to release the communication link after the reset time.

For example, the at least one processor may be configured to transmit a data signal 608 requesting read of at least one among the cache data or the pending date, stored in the non-volatile memory to the UFS device controller based on the first data processing rate, in the first state, via a communication link established after the reset time.

For example, the UFS device controller may be configured to set the specified time shorter than the reset time.

For example, the UFS device controller may be configured to identify data transmitted based on the second data processing rate through at least one of the upstream lane or the downstream lane for an identification time shorter than the specified time, independently of receiving a data signal indicating the change from the first state to the second state from the at least one processor through the UFS interface. The UFS device controller may be configured to identify the change from the first state to the second state based on identifying the transmitted data.

For example, the first data processing rate may be faster than the second data processing rate.

For example, the UFS device controller may be mounted in one package together with the storage.

In a method performed by an electronic device 101 according to an embodiment of the disclosure as described above, the method may include identifying that a state associated with a UFS interface is changed from a first state 311 in which data is transmitted based on a first data processing rate through at least one of a downstream lane and an upstream lane, to a second state 312 in which data is transmitted through at least one of the downstream lane and the upstream lane based on a second data processing rate different from the first data processing rate, based on an error 301 identified through the UFS interface 240 including the downstream lane for transmitting data from at least one processor 212 of the electronic device to a universal flash storage (UFS) device controller 222 and the upstream lane for transmitting data from the UFS device controller to the at least one processor. The method may include, while the second state is maintained, after a specified time 410 from a time point at which the change from the first state to the second state is identified, transmitting cache data stored in the cache memory from the cache memory to non-volatile memory.

For example, transmitting the cache data to the non-volatile memory may include, after the specified time for identifying whether to process cache data stored in the cache memory 230, at least temporarily refraining from writing to the cache memory.

For example, identifying the change from the first state to the second state may include identifying a reset time 315 for releasing a communication link established with the UFS device controller based on identifying the error through the UFS interface. The identifying the change from the first state to the second state may include releasing the communication link after the reset time.

For example, the transmitting the cache data to the non-volatile memory may include setting the specified time shorter than the reset time for releasing the communication link connected to the at least one processor through the UFS interface based on the error.

For example, the identifying the change from the first state to the second state may include at least temporarily refraining from requesting the UFS device controller to process data generated after a time point 302 of identifying the error during the reset time.

In a computer readable storage medium storing one or more programs according to an embodiment of the disclosure as described above, the one or more programs may be configured to, when executed by at least one processor of an electronic device 101 including at least one processor 212, a universal flash storage (UFS) device controller 222 operatively coupled to the at least one processor, a UFS interface 240 including a downstream lane for transmitting data from the at least one processor to the UFS device controller and an upstream lane for transmitting data from the UFS device controller to the at least one processor, and storage 220 including non-volatile memory 232 and cache memory 230, cause the electronic device to identify that a state associated with the UFS interface is changed from a first state 311 in which data is transmitted based on a first data processing rate through at least one of the downstream lane and the upstream lane, to a second state 312 in which data is transmitted through at least one of the downstream lane and the upstream lane based on a second data processing rate different from the first data processing rate, based on an error 301 identified through the UFS interface. The one or more programs may be configured to, when executed by the processor of the electronic device, cause the electronic device to, while the second state is maintained, after a specified time 410 from a time point at which the change from the first state to the second state is identified, transmit cache data stored in the cache memory from the cache memory to the non-volatile memory.

In a computer readable storage medium storing one or more programs according to an embodiment of the disclosure as described above, the one or more non-transitory computer-readable storage media storing one or more computer programs including computer-executable instruction that, when executed by at least one processor of an electronic device individually or collectively, cause the electronic device to perform operations, the operations comprising: based on an error identified through a universal flash storage (UFS) interface including a downstream lane for transmitting data from at least one processor of the electronic device to a UFS device controller and an upstream lane for transmitting data from the UFS device controller to the at least one processor, identifying that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate; and while the second state is maintained, after a specified time from a time point at which the change from the first state to the second state is identified, transmitting cache data stored in cache memory to non-volatile memory.

The electronic device according to various embodiments of the disclosure may be one of various types of electronic devices. The electronic devices may include, for example, a portable communication device (e.g., a smartphone), a computer device, a portable multimedia device, a portable medical device, a camera, an electronic device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as "A or B," "at least one of A and B," "at least one of A or B," "A, B, or C," "at least one of A, B, and C," and "at least one of A, B, or C," may include any one of or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," or "connected with" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
at least one processor;
a universal flash storage (UFS) device controller operatively coupled to the at least one processor;
a UFS interface including a downstream lane for transmitting data from the at least one processor to the UFS device controller and an upstream lane for transmitting data from the UFS device controller to the at least one processor; and
memory, comprising one or more storage media, storing instructions, the memory including non-volatile memory and cache memory,
wherein the at least one processor is communicatively coupled to theUFS device controller and the memory, and
wherein the instructions, when executed by the UFS device controller,cause the electronic device to:
identify that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate, based on an error identified through the UFS interface, and
while the second state is maintained, after a specified time from a time point at which the change from the first state to the second state is identified, transmit cache data stored in the cache memory to the non-volatile memory.

2. The electronic device of claim 1, wherein the instructions, when executed by the UFS device controller, further cause the electronic device to:
after the specified time, at least temporarily refrain from writing to the cache memory.

3. The electronic device of claim 1, wherein the instructions, when executed by the at least one processor individually or collectively, cause theelectronic device to:
set a reset time for releasing a communication link through the UFS interface between a UFS host device and the UFS storage device based on identifying the error through the UFS interface, and
release the communication link after the reset time.

4. The electronic device of claim 3, wherein the instructions, when executed by the UFS device controller, further cause theelectronic device to:
set the specified time shorter than the reset time for releasing the communication link based on the error.

5. The electronic device of claim 3, wherein the instructions, when executed by the at least one processor individually or collectively, further cause theelectronic device to:
at least temporarily refrain from requesting the UFS device controller to process data generated after a time point of identifying the error during the reset time.

6. The electronic device of claim 1, wherein the instructions, when executed by the UFS device controller, further cause theelectronic device to:
identify at least one among data transmitted based on the second data processing rate through at least one of the upstream lane or the downstream lane for an identification time shorter than the specified time, or a data signal indicating the change from the first state to the second state through the UFS interface and being received from the at least one processor, and
identify the change from the first state to the second state based on identifying the at least one.

7. The electronic device of claim 1, wherein the first data processing rate is faster than the second data processing rate.

8. An electronic device comprising:
at least one processor;
a universal flash storage (UFS) device controller operatively coupled to the at least one processor;
a UFS interface including a downstream lane for transmitting data from the at least one processor to the UFS device controller and an upstream lane for transmitting data from the UFS device controller to the at least one processor; and
memory, comprising one or more storage media, storing instructions, the memory including non-volatile memory and cache memory,
wherein the at least one processor is communicatively coupled to theUFS device controller and the memory,
wherein the instructions, when executed by the at least one processor individually or collectively, cause the electronic device to:
set a reset time for releasing a communication link established with the UFS device controller based on an error identified through the UFS interface, and
at least temporarily refrain from requesting the UFS device controller to process data generated after a time point of identifying the error during the reset time, and
wherein the instructions, when executed by the UFS device controller, cause the electronic device to:
identify that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate, and
while the second state is maintained, after a specified time from a time point at which the change from the first state to the second state is identified, transmit cache data stored in the cache memory from the cache memory to the non-volatile memory.

9. The electronic device of claim 8, wherein the instructions, when executed by the UFS device controller, further cause theelectronic device to:
after the specified time, at least temporarily refrain from writing to the cache memory.

10. The electronic device of claim 8, wherein the instructions, when executed by the UFS device controller, further cause theelectronic device to:
write pending data of which processing is delayed for the specified time to the non-volatile memory based on completion of the specified time.

11. The electronic device of claim 8, wherein the instructions, when executed by the at least one processor, further cause theelectronic device to:
transmit a data signal requesting read of at least one among the cache data or a pending date, stored in the non-volatile memory to the UFS device controller based on the first data processing rate, in the first state, via a communication link established after the reset time.

12. The electronic device of claim 8, wherein the instructions, when executed by the UFS device controller, further cause theelectronic device to:
set the specified time shorter than the reset time.

13. The electronic device of claim 8, wherein the instructions, when executed by the UFS device controller, further cause theelectronic device to:
identify data transmitted based on the second data processing rate through at least one of the upstream lane or the downstream lane for an identification time shorter than the specified time, independently of receiving a data signal indicating the change from the first state to the second state from the at least one processor through the UFS interface, and
identify the change from the first state to the second state based on identifying the transmitted data.

14. The electronic device of claim 8, wherein the first data processing rate is faster than the second data processing rate.

15. A method performed by an electronic device, the method comprising:
based on an error identified through a universal flash storage (UFS) interface including a downstream lane for transmitting data from at least one processor of the electronic device to a UFS device controller and an upstream lane for transmitting data from the UFS device controller to the at least one processor, identifying that a state associated with the UFS interface is changed from a first state in which data is transmitted based on a first data processing rate through at least one of the downstream lane or the upstream lane, to a second state in which data is transmitted through at least one of the downstream lane or the upstream lane based on a second data processing rate different from the first data processing rate; and
while the second state is maintained, after a specified time from a time point at which the change from the first state to the second state is identified, transmitting cache data stored in cache memory to non-volatile memory.

16. The method of claim 15, wherein the transmitting of the cache data to the non-volatile memory comprises:
after the specified time, at least temporarily refraining from writing to the cache memory.

17. The method of claim 15, wherein the identifying of the change from the first state to the second state comprises:
identifying a reset time for releasing a communication link through the UFS interface between a UFS host device and a UFS storage device based on identifying the error through the UFS interface; and
releasing the communication link after the reset time.

18. The method of claim 17, wherein the transmitting of the cache data to the non-volatile memory comprises:
setting the specified time shorter than the reset time for releasing the communication link based on the error.

19. The method of claim 17, wherein the identifying of the change from the first state to the second state comprises:
at least temporarily refraining from requesting the UFS device controller to process data generated after a time point of identifying the error during the reset time.

20. The method of claim 15, further comprising:
identifying at least one among data transmitted based on the second data processing rate through at least one of the upstream lane or the downstream lane for an identification time shorter than the specified time, or a data signal indicating the change from the first state to the second state through the UFS interface and being received from the at least one processor; and
identifying the change from the first state to the second state based on identifying the at least one.
